(19) United States
(12) Patent Application Publication
(10) Pub. No.: US 2014/0184737 A1
(43) Pub. Date: Jul. 3, 2014

(54) DRIVING ASSISTANT SYSTEM AND METHOD

(71) Applicants: HON HAI PRECISION INDUSTRY CO., LTD., New Taipei (TW); HONG FU JIN PRECISION INDUSTRY (SHENZHEN) CO., LTD., Shenzhen (CN)

(72) Inventor: KANG-BIN WANG, Shenzhen (CN)

(73) Assignees: HON HAI PRECISION INDUSTRY CO., LTD., New Taipei (TW); HONG FU JIN PRECISION INDUSTRY (SHENZHEN) CO., LTD., Shenzhen (CN)

(21) Appl. No.: 13/971,747

(22) Filed: Aug. 20, 2013

(30) Foreign Application Priority Data
Dec. 27, 2012 (CN) 2012105774809

(51) Int. Cl. G08G 1/04; H04N 5/232

(52) U.S. Cl. CPC G08G 1/04; H04N 5/23238
USPC 348/36

(57) ABSTRACT

A driving assistant system includes a plurality of cameras configured to capture wide-angle views around a vehicle; a monitor, a Field-Programmable Gate Array (FPGA) connected to the plurality of cameras, and a digital signal processor connected to the FPGA and the monitor. The FPGA converts the wide-angle images to flat plane images. The digital signal processor combines the plane images into a single panoramic image and sends the panoramic image to the monitor. The monitor displays the panoramic image, to assist the driver by eliminating any blind spots. The present disclosure further discloses a driving assistant method based upon the above driving assistant system.

### BACKGROUND

This application are related to co-pending application entitled, “DRIVING ASSISTANT SYSTEM AND METHOD,” filed on ***, application Ser. No. ***, (Atty. Docket No. US48635), and “DRIVING ASSISTANT SYSTEM AND METHOD,” filed on ***, application Ser. No. ***, (Atty. Docket No. US48636).

### TECHNICAL FIELD

The present disclosure relates to a driving assistant system and method.

### DESCRIPTION OF RELATED ART

For safety while driving, a small camera is mounted on a vehicle and directed to a specific direction to take an image not directly viewable by a driver's eye. The taken image is displayed on a monitor of the vehicle. However, the camera cannot take images surrounding the vehicle, and some blind spots still exist.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of an embodiment of a driving assistant system.

FIG. 2 illustrates mounting positions of four cameras of the driving assistant system of FIG. 1.

FIG. 3 illustrates a flow chart of an embodiment of a driving assistant method.

### DETAILED DESCRIPTION

The disclosure is illustrated by way of example and not by way of limitation. In the figures of the accompanying drawings in which like references indicate similar elements. It should be noted that references to “an” or “one” embodiment in this disclosure are not necessarily to the same embodiment, and such references mean “at least one.”

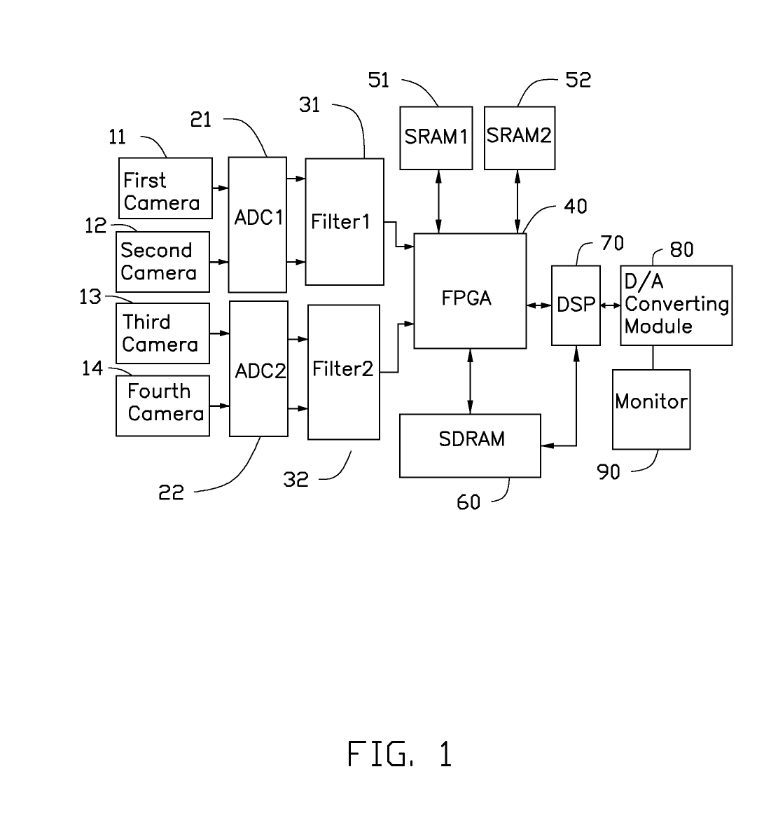

FIG. 1 shows an embodiment of a driving assistant system comprising a plurality of cameras, a first analog-to-digital (A/D) converter 21, a second A/D converter 22, a first filter module 31, a second filter module 32, a Field-Programmable Gate Array (FPGA) 40, a digital signal processor (DSP) 70, a digital-to-analog (D/A) converter 80, and a monitor 90. The plurality of cameras comprises a first camera 11, a second camera 12, a third camera 13, and a fourth camera 14. A first Static Random Access Memory (SRAM) 51 and a second SRAM 52 are connected to the FPGA 40 to store static data for the FPGA 40. A Dynamic Random Access memory (DRAM) 60 is connected to the FPGA 40 to store dynamic data for the FPGA 40.

The first camera 11 and the second camera 12 are connected to the first A/D converter 21. The third camera 13 and the fourth camera 14 are connected to the second A/D converter 22. The first A/D converter 21 is connected to the first filter module 31. The second A/D converter 22 is connected to the second filter module 32. Output terminals of the first filter module 31 and the second filter module 32 are connected to the FPGA 40. The DSP 70 is connected to the FPGA 40. The D/A converter 80 is connected to the DSP 70. The monitor 90 is connected to the D/A converter 80.

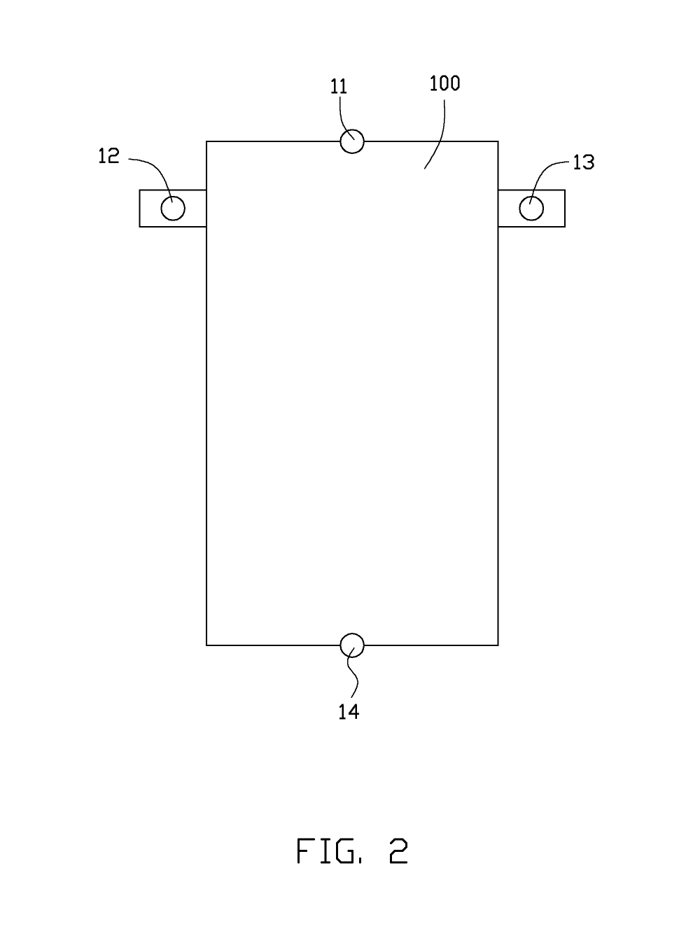

FIG. 2 shows mounting positions of the first camera 11, a second camera 12, a third camera 13, and a fourth camera 14. In one embodiment, the first camera 11 is attached to a front central portion of a vehicle 100. The second camera 12 and the third camera 13 can be attached to two rearview mirrors of the vehicle 100. The fourth camera 14 is attached to a rear central portion of the vehicle 100. Each of the plurality of cameras is a wide-angle lens infrared camera (e.g., 170 degrees lens). The plurality of cameras can capture images around the vehicle, thus virtually eliminating any blind spot.

Each of the plurality of cameras comprises a fish-eye lens to capture a wide-angle image around the vehicle 100. The fish-eye image comprises analog signals which carry information of the fish-eye image. The first A/D converter 21 and the second A/D converter 22 convert analog signals to digital signals. The digital signals are filtered by the first filter module 31 and the second filter module 32. The

FPGA 40 converts the digital signals of the fish-eye image into digital signals representing a plane or flat image. Thus, the fish-eye image can be converted to a plane image. The DSP 70 combines the converted digital signals coming from the plurality of cameras to obtain a panoramic image which provides a 360° view around the vehicle 100. The combined digital signals are converted to analog signals by the

D/A converter 80 for display on the monitor 90. The monitor 90 displays the panoramic image. The DSP 70 increases the data processing speed of the driving assistant system. In one embodiment, the FPGA 40 is an XC6SLX45 chip. The DSP 70 is a TMS320DM643 chip.

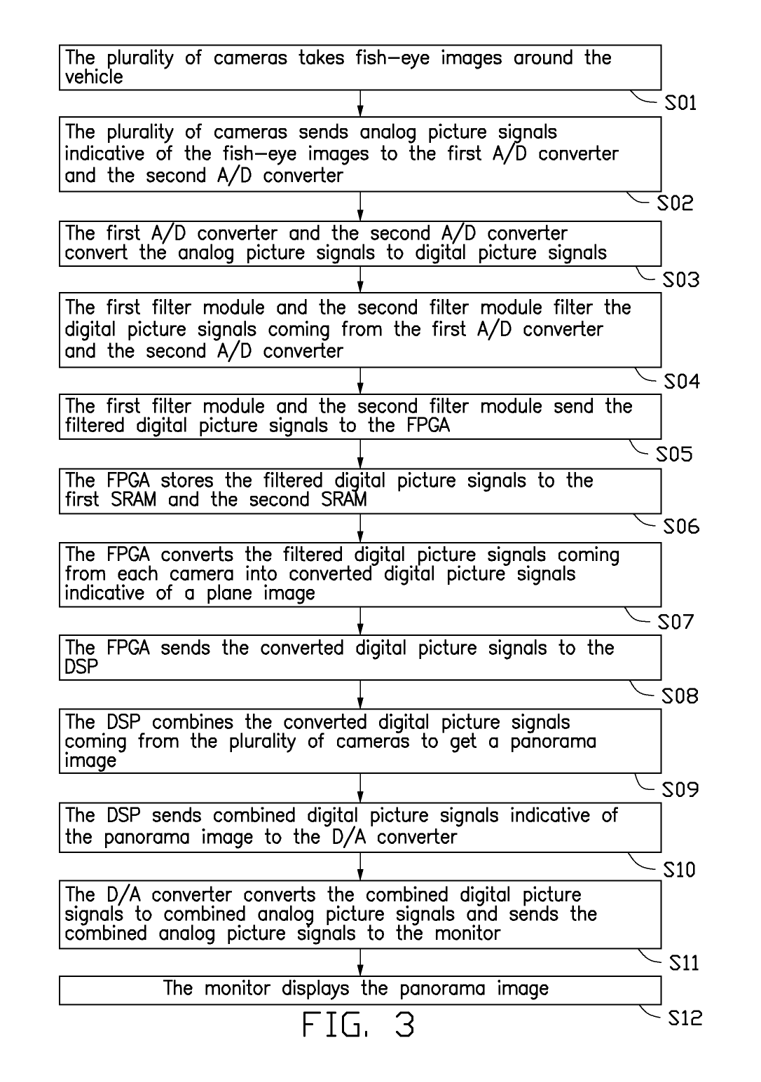

FIG. 3 shows a flow chart of an embodiment of a driving assistant method based upon the above driving assistant system. The driving assistant method comprises the following blocks.

In block S01, the plurality of cameras take fish-eye images around the vehicle 100.

In block S02, the plurality of cameras sends analog signals of the fish-eye images to the first A/D converter 21 and the second A/D converter 22. In particular, analog signals coming from the first camera 11 and the second camera are sent to the first A/D converter 21. Analog signals coming from the third camera 13 and the fourth camera 14 are sent to the second A/D converter 22.

In block S03, the first A/D converter 21 and the second A/D converter 22 convert the analog signals to digital signals. In particular, the first A/D converter 21 converts the analog signals coming from the first camera 11 and the second camera 12 to digital signals. The second A/D converter 22 converts the analog signals coming from the third camera 13 and the fourth camera 14 to digital signals.

In block S04, the first filter module 31 and the second filter module 32 filter the digital signals output from the first A/D converter 21 and the second A/D converter 22. In particularly, the first filter module 31 filters the digital signals coming from the first A/D converter 21. The second filter module 32 filters the digital signals coming from the second A/D converter 22.

In block S05, the first filter module 31 and the second filter module 32 send the filtered digital signals to the FPGA 40.

In block S06, the FPGA 40 stores the filtered digital signals to the first SRAM 51 and the second SRAM 52. In particular, the filtered digital signals coming from the first filter module 31 are stored in the first SRAM 51. The filtered digital signals coming from the second filter module 32 are stored in the second SRAM 52.

In block S07, the FPGA 40 converts the filtered digital signals coming from each camera into a single digital image representing a plane or flat image. Thus, each fish-eye image captured by each of the plurality of cameras is converted and adds to the plane image.

In block S08, the FPGA 40 sends the converted digital signals to the DSP 70.

In block S09, the DSP 70 combines the converted digital signals coming from the FPGA 40 to obtain a panoramic image which provides a 360° view around the vehicle. The fish-eye images captured by the plurality of cameras have overlapping areas. In this combining step, the DSP 70 takes average data of the overlapping areas.

In block S10, the DSP 70 sends combined digital signals representing the panoramic image to the D/A converter 80.

In block S11, the D/A converter 80 converts the digital signals representing the panoramic image to analog signals and sends the panoramic analog signals to the monitor 90.

In block S12, the monitor 90 displays the panoramic image.

While the present disclosure has been illustrated by the description of embodiments thereof, and while the preferred embodiments have been described in considerable detail, it is not intended to restrict or in any way limit the scope of the appended claims to such details. Additional advantages and modifications within the spirit and scope of the present disclosure will readily appear to those skilled in the art. Therefore, the present disclosure is not to be limited to the specific details and illustrative examples shown and described.

Depending on the embodiment, certain of the steps of methods described may be removed, others may be added, and the sequence of steps may be altered. It is also to be understood that the description and the claims drawn to a method may include some indication in reference to certain steps. However, any indication used is only to be viewed for identification purposes and not as a suggestion as to an order for the steps.

What is claimed is:

1. A driving assistant system comprising:
a plurality of cameras configured to capture fish-eye images around a vehicle;
a monitor;
a Field-Programmable Gate Array (FPGA) connected to the plurality of cameras, the FPGA converting the fish-eye images to plane images; and
a digital signal processor connected to the FPGA and the monitor, wherein the digital signal processor combines the plane images into a panorama image and sends the panorama image to the monitor to display the panorama image.

2. The driving assistant system of claim 1, wherein the plurality of cameras comprises a first camera attached to a front central portion of the vehicle, a second camera attached to a first rearview mirror of the vehicle, a third camera attached to a second rearview mirror of the vehicle, and a fourth camera attached to a rear central portion of the vehicle.

3. The driving assistant system of claim 2, further comprising a first analog-to-digital (A/D) converter connected to the first camera and the second camera and a second A/D converter connected to the third camera and the fourth camera, wherein each of the fish-eye images comprises analog picture signals, the first A/D converter converts analog picture signals coming from the first camera and the second camera, and the second A/D converter converts analog picture signals coming from the third camera and the fourth camera.

4. The driving assistant system of claim 3, further comprising a first filter module connected to the first A/D converter and a second filter module connected to the second A/D converter, wherein the first filter module filters digital picture signals output from the first A/D converter, and the second filter module filters digital picture signals output from the second A/D converter.

5. The driving assistant system of claim 1, further comprising a plurality of static random access memories and a dynamic random access memory connected to the FPGA to help the FPGA to store static and dynamic data.

6. The driving assistant system of claim 5, wherein the plurality of static random access memories comprises a first SRAM configured to store image signals coming from the first camera and the second camera and a second SRAM configured to store image signals coming from the third camera and the fourth camera.

7. The driving assistant system of claim 1, wherein each of the plurality of cameras is a wide-angle lens camera.

8. The driving assistant system of claim 7, wherein each of the plurality of cameras is a 170 degrees lens infrared camera.

9. A driving assistant method, comprising:
utilizing a plurality of cameras to capture fish-eye images around a vehicle in different positions and directions;
converting the fish-eye images into plane images using a Field-Programmable Gate Array (FPGA);
combining the plane images into a panorama image using a digital signal processor (DSP); and
displaying the panorama image which shows traffic conditions around the vehicle.

10. The driving assistant method of claim 9, further comprising sending the plane images to the DSP before the combining step.

11. The driving assistant method of claim 10, further comprising utilizing a first analog-to-digital (A/D) converter and a second A/D converter to convert analog picture signals of the fish-eye images to digital picture signals before converting the fish-eye image.

12. The driving assistant method of claim 11, further comprising filtering the digital picture signals and sending the filtered digital picture signals to the FPGA.

13. The driving assistant method of claim 12, wherein the panorama image shows traffic conditions completely around the vehicle.
